(19) United States
(12) Patent Application Publication
(10) Pub. No.: US 2011/0098114 A1
(43) Pub. Date: Apr. 28, 2011

(54) BEHAVIOR CONTROL DATA GENERATION SYSTEM, GENERATION METHOD FOR BEHAVIOR CONTROL DATA, INFORMATION PROCESSING DEVICE, CONTROL METHOD FOR AN INFORMATION PROCESSING DEVICE, AND INFORMATION STORAGE MEDIUM

(75) Inventor: Zenta ISHIDA, Tochigi (JP)

(73) Assignee: KONAMI DIGITAL ENTERTAINMENT CO., LTD., Tokyo (JP)

(21) Appl. No.: 12/911,557

(22) Filed: Oct. 25, 2010

(30) Foreign Application Priority Data
Oct. 26, 2009 (JP) 2009-245965

(51) Int. Cl. A63F 13/06; A63F 9/24

(52) U.S. Cl. 463/36; 463/43

(57) ABSTRACT

A base data acquisition section acquires, as base data, a combination of operation data related to an operation performed by a user between a first time corresponding to a collision between a moving object and any one of predetermined objects and a second time corresponding to a subsequent collision between the moving object and any one of the predetermined objects, and state data related to a state of a plurality of character objects or a plurality of character object groups and the moving object at the first time.

### CROSS-REFERENCE TO RELATED APPLICATION

The present application claims priority from Japanese application JP2009-245965 filed on Oct. 26, 2009, the content of which is hereby incorporated by reference into this application.

### BACKGROUND OF THE INVENTION

1. Field of the Invention

The present invention relates to a behavior control data generation system, a generation method for behavior control data, an information processing device, a control method for an information processing device, and an information storage medium.

2. Description of the Related Art

For example, there is known a game configured such that a character object or a character object group operated by a user and a character object or a character object group operated by a computer behave. Further, there is known a technology for causing the character object or the character object group operated by the computer to behave as if being operated by a person in such a game. For example, if the character object or the character object group operated by the computer behaves as if being operated by a skilled player, the user can enjoy a virtual competition against the skilled player.

JP11-4969A discloses a technology of causing a character operated by the computer to behave as if being operated by a person by generating behavior control data used for controlling behavior of the character operated by the computer in a combat game based on a game operation performed when the person actually played the combat game. Specifically, according to the disclosure, the behavior control data is generated by focusing on the game operation performed by the person when an attack (for example, punch or kick) performed by a character operated by the person hits a competitor character.

### SUMMARY OF THE INVENTION

It is strongly desired that a character object or a character object group operated by a computer also be caused to behave as if being operated by a person in a game of a competition (sport, for example, soccer or tennis) performed by using a moving object such as a ball.

However, the game of the competition performed by using the moving object is different from a combat game, and hence the technology disclosed in JP11-4969A cannot be applied as it is to the game of the competition performed by using the moving object. This is because the game of the competition performed by using the moving object is not a game to be operated with the aim of causing an attack to hit a competitor character object or competitor character object group. Therefore, the technology disclosed in JP11-4969A, that is, the technology of generating behavior control data by focusing on a game operation performed by a person when an attack of the character object operated by the person hits the competitor character object, cannot be applied as it is to the game of the competition performed by using the moving object.

Therefore, in order to cause the character object or the character object group operated by the computer to behave as if being operated by a person in the game of the competition performed by using the moving object, it is necessary to provide a mechanism dedicated to the game of the competition performed by using the moving object.

The present invention has been made in view of the above-mentioned problem, and an object thereof is to provide a behavior control data generation system, a generation method for behavior control data, an information processing device, a control method for an information processing device, and an information storage medium, which are capable of causing a character object or a character object group operated by a computer to behave as if being operated by a person in a game configured such that a plurality of character objects or a plurality of character object groups perform a competition using a moving object within a game space.

In order to solve the above-mentioned problem, a behavior control data generation system according to the present invention is a behavior control data generation system including: play data acquisition means for acquiring (1) data related to change instate of a plurality of character objects or a plurality of character object groups and a moving object in a case where a person plays a game by operating any one of the plurality of character objects or any one of the plurality of character object groups, the game being configured such that the plurality of character objects or the plurality of character object groups perform a competition using the moving object within a game space, and (2) data related to an operation performed by the person in the case where the person plays the game by operating the any one of the plurality of character objects or the any one of the plurality of character object groups; base data acquisition means for acquiring base data based on the data acquired by the play data acquisition means, the base data being used for generating behavior control data used for controlling behavior of a character object or a character object group that is operated by a computer in the game; and behavior control data generation means for generating the behavior control data based on the base data acquired by the base data acquisition means, in which the base data acquisition means acquires a combination of operation data and state data as the base data, the operation data being related to an operation performed by the person between a first time corresponding to a collision between the moving object and any one of predetermined objects located in the game space and a second time corresponding to a subsequent collision between the moving object and any one of the predetermined objects located in the game space, the state data being related to a state of the plurality of character objects or the plurality of character object groups and the moving object at the first time.

Further, a generation method for behavior control data according to the present invention is a method including: a play data acquisition step of acquiring (1) data related to change in state of a plurality of character objects or a plurality of character object groups and a moving object in a case where a person plays a game by operating any one of the plurality of character objects or any one of the plurality of character object groups, the game being configured such that the plurality of character objects or the plurality of character object groups perform a competition using the moving object within a game space, and (2) data related to an operation performed by the person in the case where the person plays the game by operating the any one of the plurality of character objects or the any one of the plurality of character object groups; a base data acquisition step of acquiring base data based on the data acquired in the play data acquisition step, the base data being used for generating behavior control data used for controlling behavior of a character object or a character object group that is operated by a computer in the game; and a behavior control data generation step of generating the behavior control data based on the base data acquired in the base data acquisition step, in which the base data acquisition step comprises acquiring a combination of operation data and state data as the base data, the operation data being related to an operation performed by the person between a first time corresponding to a collision between the moving object and any one of predetermined objects located in the game space and a second time corresponding to a subsequent collision between the moving object and any one of the predetermined objects located in the game space, the state data being related to a state of the plurality of character objects or the plurality of character object groups and the moving object at the first time.

Further, a program according to the present invention is a program for causing a computer to function as: play data acquisition means for acquiring (1) data related to change in state of a plurality of character objects or a plurality of character object groups and a moving object in a case where a person plays a game by operating any one of the plurality of character objects or any one of the plurality of character object groups, the game being configured such that the plurality of character objects or the plurality of character object groups perform a competition using the moving object within a game space, and (2) data related to an operation performed by the person in the case where the person plays the game by operating the any one of the plurality of character objects or the any one of the plurality of character object groups; base data acquisition means for acquiring base data based on the data acquired by the play data acquisition means, the base data being used for generating behavior control data used for controlling behavior of a character object or a character object group that is operated by a computer in the game; and behavior control data generation means for generating the behavior control data based on the base data acquired by the base data acquisition means, in which the base data acquisition means acquires a combination of operation data and state data as the base data, the operation data being related to an operation performed by the person between a first time corresponding to a collision between the moving object and any one of predetermined objects located in the game space and a second time corresponding to a subsequent collision between the moving object and any one of the predetermined objects located in the game space, the state data being related to a state of the plurality of character objects or the plurality of character object groups and the moving object at the first time. Further, an information storage medium according to the present invention is a computer-readable information storage medium storing the above-mentioned program.

Further, an information processing device according to the present invention is an information processing device including: play data acquisition means for acquiring (1) data related to change in state of a plurality of character objects or a plurality of character object groups and a moving object in a case where a person plays a game by operating any one of the plurality of character objects or any one of the plurality of character object groups, the game being configured such that the plurality of character objects or the plurality of character object groups perform a competition using the moving object within a game space, and (2) data related to an operation performed by the person in the case where the person plays the game by operating the any one of the plurality of character objects or the any one of the plurality of character object groups; and base data acquisition means for acquiring base data based on the data acquired by the play data acquisition means, the base data being used for generating behavior control data used for controlling behavior of a character object or a character object group that is operated by a computer in the game, in which the base data acquisition means acquires a combination of operation data and state data as the base data, the operation data being related to an operation performed by the person between a first time corresponding to a collision between the moving object and any one of predetermined objects located in the game space and a second time corresponding to a subsequent collision between the moving object and any one of the predetermined objects located in the game space, the state data being related to a state of the plurality of character objects or the plurality of character object groups and the moving object at the first time.

Further, a control method for an information processing device according to the present invention is a method including: a play data acquisition step of acquiring (1) data related to change in state of a plurality of character objects or a plurality of character object groups and a moving object in a case where a person plays a game by operating any one of the plurality of character objects or any one of the plurality of character object groups, the game being configured such that the plurality of character objects or the plurality of character object groups perform a competition using the moving object within a game space, and (2) data related to an operation performed by the person in the case where the person plays the game by operating the any one of the plurality of character objects or the any one of the plurality of character object groups; and a base data acquisition step of acquiring base data based on the data acquired in the play data acquisition step, the base data being used for generating behavior control data used for controlling behavior of a character object or a character object group that is operated by a computer in the game, in which the base data acquisition step comprises acquiring a combination of operation data and state data as the base data, the operation data being related to an operation performed by the person between a first time corresponding to a collision between the moving object and any one of predetermined objects located in the game space and a second time corresponding to a subsequent collision between the moving object and any one of the predetermined objects located in the game space, the state data being related to a state of the plurality of character objects or the plurality of character object groups and the moving object at the first time.

Further, a program according to the present invention is a program for causing a computer to function as: play data acquisition means for acquiring (1) data related to change in state of a plurality of character objects or a plurality of character object groups and a moving object in a case where a person plays a game by operating any one of the plurality of character objects or any one of the plurality of character object groups, the game being configured such that the plurality of character objects or the plurality of character object groups perform a competition using the moving object within a game space, and (2) data related to an operation performed by the person in the case where the person plays the game by operating the any one of the plurality of character objects or the any one of the plurality of character object groups; and base data acquisition means for acquiring base data based on the data acquired by the play data acquisition means, the base data being used for generating behavior control data used for controlling behavior of a character object or a character object group that is operated by a computer in the game, in which the base data acquisition means acquires a combination of operation data and state data as the base data, the operation data being related to an operation performed by the person between a first time corresponding to a collision between the moving object and any one of predetermined objects located in the game space and a second time corresponding to a subsequent collision between the moving object and any one of the predetermined objects located in the game space, the state data being related to a state of the plurality of character objects or the plurality of character object groups and the moving object at the first time. Further, an information storage medium according to the present invention is a computer-readable information storage medium storing the above-mentioned program.

According to the present invention, it is possible to cause the character object or the character object group operated by the computer to behave as if being operated by a person in the game configured to such that the plurality of character objects or the plurality of character object groups perform a competition using the moving object within the game space. Note that the “moving object” is an object representing such a moving object as a ball, a puck, or a shuttlecock. The “predetermined objects” include, for example, the character object. Further, the “predetermined objects” include, for example, an athletic equipment object representing equipment necessary to perform a competition (excluding the above-mentioned moving object). The “athletic equipment object” may be an object representing a thing located on the ground or the like, such as a goal for soccer, and may be an object representing a thing used for hitting the moving object, such as a stick for ice hockey or a racket for tennis.

Further, in one aspect of the present invention, the base data acquisition means may acquire, as the base data, a combination of the operation data, first state data related to the state of the plurality of character objects or the plurality of character object groups and the moving object at the first time, and second state data related to a state of the plurality of character objects or the plurality of character object groups and the moving object at a time or in a period prior to the first time.

Further, in one aspect of the present invention, the base data acquisition means may acquire, as the base data, a combination of the operation data, the state data, and game event data related to a game event that occurs after the first time.

Further, in one aspect of the present invention, the base data acquisition means may acquire, as the base data, a combination of the operation data, the state data, and data related to a progress status of the competition at the first time.

Further, in one aspect of the present invention, the base data acquisition means may acquire, as the base data, a combination of the operation data, the state data, and data related to a halfway result of the competition at the first time.

### BRIEF DESCRIPTION OF THE DRAWINGS

In the accompanying drawings:

FIG. 1 is a diagram illustrating an example of a configuration of a behavior control data generation system according to an embodiment of the present invention;

FIG. 2 is a diagram illustrating an example of a game screen;

FIG. 3 is a diagram illustrating an example of a game space;

FIG. 4 is a diagram illustrating an example of a game controller;

FIG. 5 is a diagram illustrating an example of the game controller;

FIG. 6 is a diagram illustrating an example of a relationship between respective buttons of the game controller and control related to a highlighted player character of a user team;

FIG. 7 is a functional block diagram of the behavior control data generation system;

FIG. 8 is a diagram illustrating an example of functional blocks included in a play data acquisition section;

FIG. 9 is a diagram for describing a point to be aware of when base data is acquired;

FIG. 10 is a diagram for describing an example of a scene in a soccer game;

FIG. 11 is a diagram for describing another example of the scene in the soccer game;

FIG. 12 is a diagram for describing an example of the base data;

FIG. 13 is a flowchart illustrating an example of processing executed by the behavior control data generation system;

FIG. 14 is a diagram illustrating an example of storage contents of an operation storage area;

FIG. 15 is a diagram illustrating an example of a highlighted player control data;

FIG. 16 is a flowchart illustrating an example of processing executed by a game device;

FIG. 17 is a diagram for describing another example of the base data;

FIG. 18 is a diagram for describing another example of the highlighted player control data;

FIG. 19 is a flowchart illustrating an example of the processing executed by the game device;

FIG. 20 is a diagram illustrating a further example of the base data;

FIG. 21 is a diagram illustrating a further example of the highlighted player control data;

FIG. 22 is a diagram illustrating a still further example of the base data;

FIG. 23 is a diagram illustrating a still further example of the highlighted player control data;

FIG. 24 is a diagram illustrating a yet further example of the base data;

FIG. 25 is a diagram illustrating a yet further example of the highlighted player control data; and

FIG. 26 is a diagram illustrating another example of the configuration of the behavior control data generation system according to the embodiment of the present invention.

### DETAILED DESCRIPTION OF THE INVENTION

Hereinafter, an example of an embodiment of the present invention is described in detail with reference to the accompanying drawings.

### Configuration

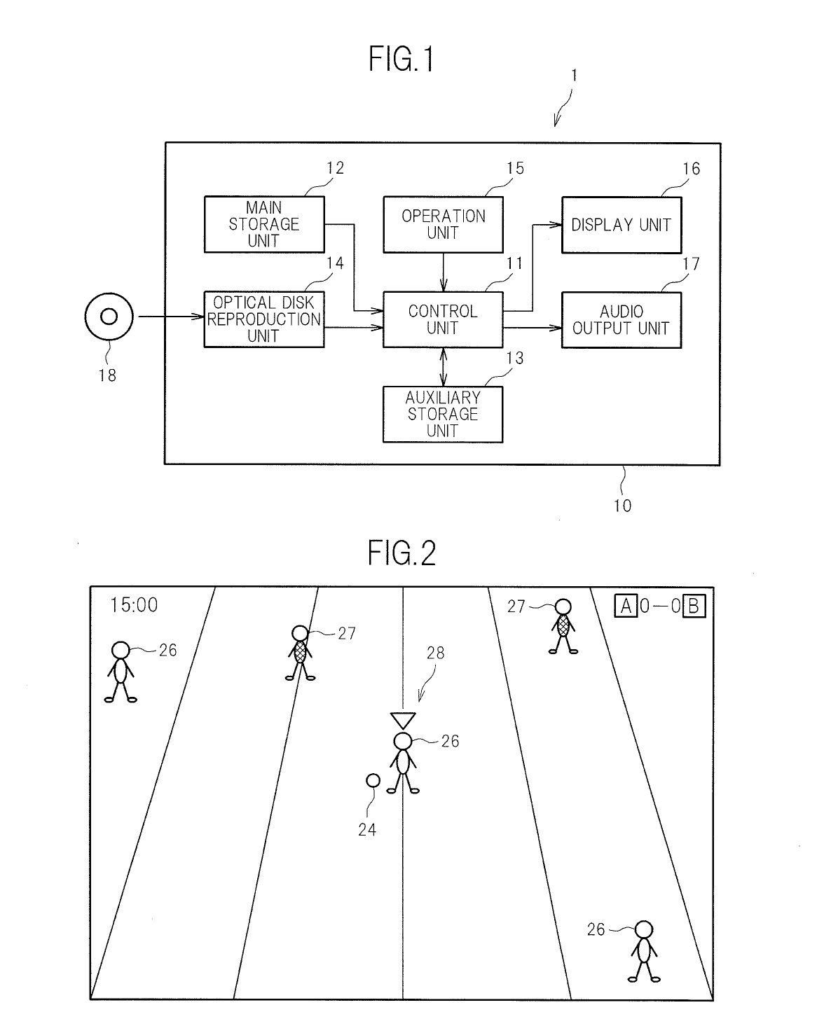

FIG. 1 is a diagram illustrating an example of a configuration of a behavior control data generation system according to an embodiment of the present invention. As illustrated in FIG. 1, a behavior control data generation system 1 according to this embodiment includes a behavior control data generation device 10.

The behavior control data generation device 10 is, for example, an information processing device for game development used when a developer of a game develops the game. The information processing device has a function for performing game programming or the like. In addition, the information processing device also has a function as a game device for executing the game, and the game can be played on the information processing device.

As illustrated in FIG. 1, the behavior control data generation device 10 includes a control unit 11, a main memory unit 12, an auxiliary storage unit 13, an optical disk reproduction unit 14, an operation unit 15, a display unit 16, and an audio output unit 17.

The control unit 11 includes, for example, a microprocessor. The control unit 11 executes information processing according to a program. The main memory unit 12 includes, for example, a RAM. The main memory unit 12 stores a program and data read from the auxiliary storage unit 13 or an optical disk. Further, the main memory unit 12 is also used as a working memory for storing data needed in the course of processing. The auxiliary storage unit 13 includes, for example, a hard disk drive unit. The optical disk reproduction unit 14 reads a program and data stored in an optical disk 18.

The operation unit 15 includes, for example, a keyboard and a game controller. The display unit 16 is a display device such as a home-use television set or a liquid crystal monitor, and outputs the screen according to an instruction from the control unit 11. The audio output unit 17 is, for example, a speaker or a headphone, and outputs audio according to the instruction from the control unit 11.

In the behavior control data generation system 1 having the above-mentioned configuration, there is generated behavior control data used for controlling the behavior of the character object or the character object group operated by a computer in the game configured such that a plurality of character objects or a plurality of character object groups perform a competition using a moving object within a game space. In the behavior control data generation system 1, such behavior control data as to cause the character object or the character object group operated by the computer to behave as if being operated by a person is generated.

Hereinafter, an operation of the behavior control data generation system 1 is described by taking an example of a case of generating the behavior control data used for controlling the behavior of a computer team in a soccer game configured such that a user team being a team (character object group) operated by a user and the computer team being a team (character object group) operated by a computer perform a soccer match.

### Regarding Soccer Game

The soccer game is described before describing the operation of the behavior control data generation system 1.

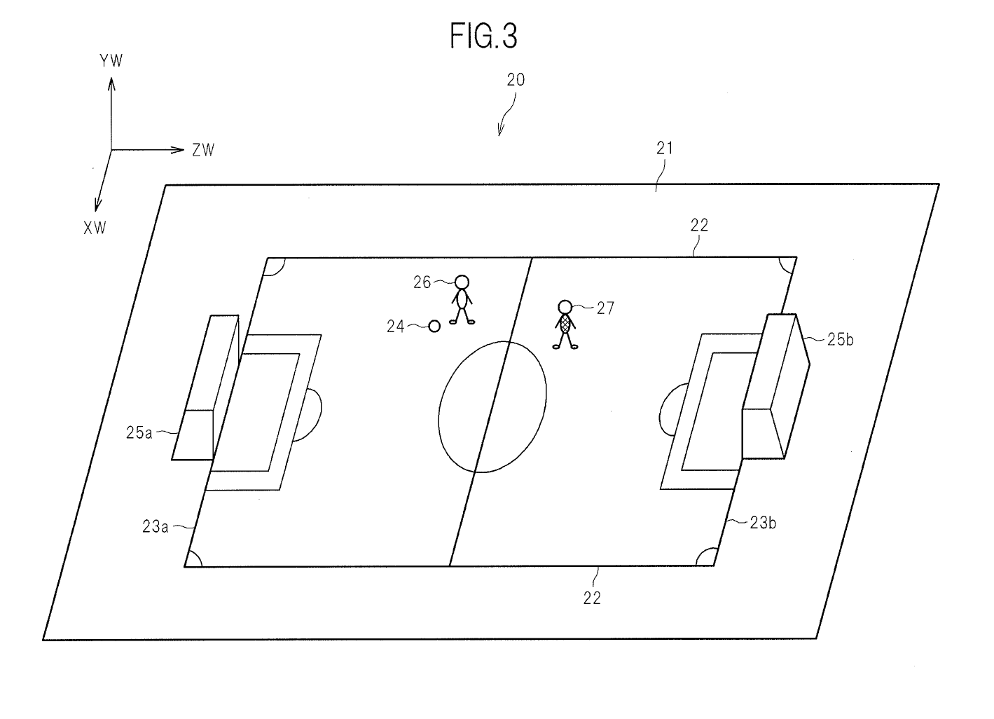

FIG. 2 is a diagram illustrating an example of a game screen of the soccer game, and FIG. 3 is a diagram illustrating an example of the game space. A game space 20 illustrated in FIG. 3 is a virtual three-dimensional space. As illustrated in FIG. 2, a state of the game space 20 viewed from a given viewpoint is displayed on the game screen.

As illustrated in FIG. 3, a field object 21 (hereinafter, referred to simply as “field 21”) representing a soccer field is located in the game space 20. Two sidelines 22 and two goal lines 23a and 23b are drawn on the field 21. Hereinafter, a region surrounded by the two sidelines 22 and the two goal lines 23a and 23b is called a “pitch”.

Further, the following objects are located in the field 21:
(a) a ball object 24 (moving object) representing a soccer ball;
(b) a goal object 25a (athletic equipment object) to be defended by the user team;
(c) a goal object 25b (athletic equipment object) to be defended by the computer team;
(d) a player character object 26 representing a soccer player belonging to the user team; and
(e) a player character object 27 representing a soccer player belonging to the computer team.

Note that, hereinafter, the ball object 24 is referred to simply as “ball 24”. Further, the goal object 25a and the goal object 25b are referred to simply as “goal 25a” and “goal 25b”, respectively.

In addition, the player character object 26 and the player character object 27 are referred to simply as “player character 26” and “player character 27”, respectively.

The ball 24 is capable of moving within the game space 20. Further, when the ball 24 comes near a player character 26 (27), the ball 24 is associated with the player character 26 (27). When the ball 24 is associated with the player character 26 (27), the player character 26 (27) comes to a “state of being in possession of the ball 24”. A movement action of the player character 26 (27) in possession of the ball 24 becomes a dribbling action.

A scoring event for the computer team (point losing event for the user team) occurs if the ball 24 moves into a region within the goal 25a, and the scoring event for the user team (point losing event for the computer team) occurs if the ball 24 moves into a region within the goal 25b.

Further, in the case where the ball 24 goes out of the pitch across the goal line 23b being a goal line corresponding to the goal 25b of the computer team, if the last player character that touched the ball 24 is the player character 27 belonging to the computer team, a corner kick event for the user team occurs. Meanwhile, if the last player character that touched the ball 24 is the player character 26 belonging to the user team, a goal kick event for the computer team occurs.

Note that, although omitted in FIG. 3, eleven player characters 26 belonging to the user team and eleven player characters 27 belonging to the computer team are located in the game space 20.

Any one of the eleven player characters 26 belonging to the user team is set as a “highlighted player character (selected player character)”. In the case of the user team, the highlighted player character is an operation target of the user, and behaves according to the user's operation. A cursor 28 displayed on the game screen illustrated in FIG. 2 plays a role of indicating the highlighted player character of the user team. The user uses the game controller to operate the highlighted player character of the user team.

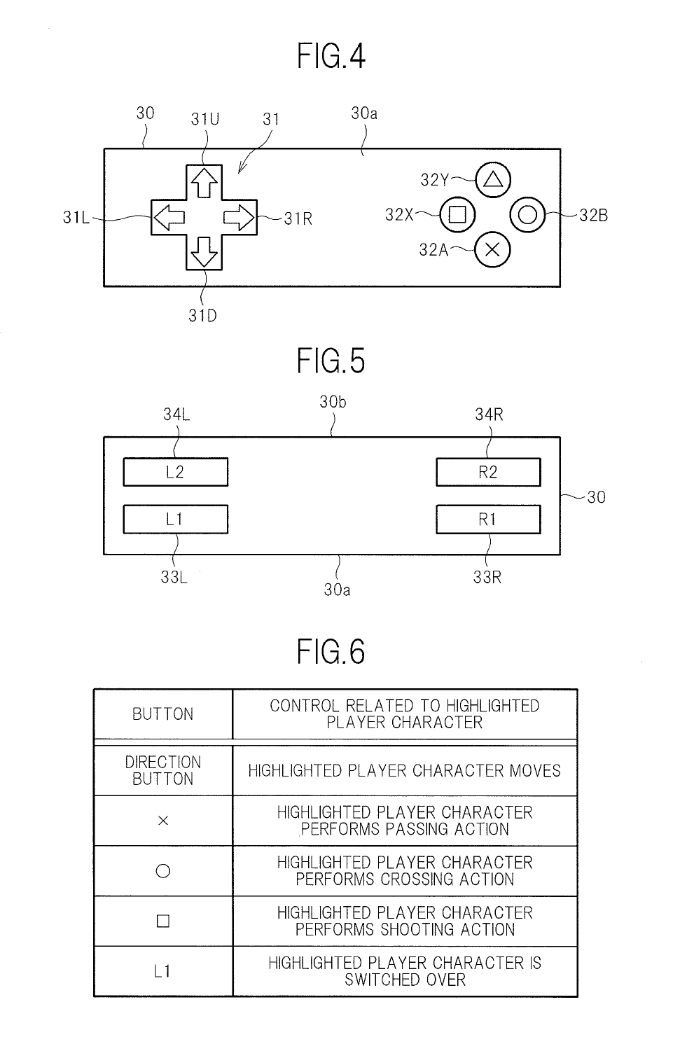

FIG. 4 and FIG. 5 are diagrams illustrating an example of the game controller used for playing the soccer game. As illustrated in FIG. 4, a game controller 30 includes a direction button 31 and buttons 32X, 32Y, 32A, and 32B on a front side 30a. The direction button 31 includes an upward direction portion 31U, a downward direction portion 31D, a leftward direction portion 31L, and a rightward direction portion 31R. Arrow marks indicating the respective directions of up/down/left/right are added to the surfaces of the upward direction portion 31U, the downward direction portion 31D, the leftward direction portion 31L, and the rightward direction portion 31R.

Further, a square mark is added to the button 32X, and a triangle mark is added to the button 32Y. In addition, a cross mark is added to the button 32A, and a circle mark is added to the button 32B.

Further, as illustrated in FIG. 5, on a rear side surface of the game controller 30, buttons 33L and 33R are provided to left and right portions near the front side 30a, respectively, and buttons 34L and 34R are provided to left and right portions near a back side 30b, respectively. The character string “L1” is added to the button 33L, and the character string “R1” is added to the button 33R. Further, the character string “L2” is added to the button 34L, and the character string “R2” is added to the button 34R.

FIG. 6 is a diagram illustrating an example of a relationship between the respective buttons of the game controller 30 and control related to the highlighted player character of the user team. Note that, in FIG. 6, the buttons other than the direction button 31 are indicated by the marks added to the buttons.

When the user depresses the direction button 31, the highlighted player character of the user team moves in a direction corresponding to a depressed state of the direction button 31. Note that in a case where the highlighted player character is in possession of the ball 24, the highlighted player character performs a dribbling action in the direction corresponding to the depressed state of the direction button 31.

In a case where the user depresses the button 32A while the highlighted player character of the user team is in possession of the ball 24, the highlighted player character performs a passing action. Further, in a case where the user depresses the button 32B while the highlighted player character of the user team is in possession of the ball 24, the highlighted player character performs a crossing action. In addition, in a case where the user depresses the button 32X while the highlighted player character of the user team is in possession of the ball 24, the highlighted player character performs a shooting action.

Further, in a case where the user depresses the button 33L, the highlighted player character is switched to another player character 26 of the eleven player characters 26 belonging to the user team. For example, another player character 26 closest to the player character 26 being the highlighted player character becomes a new highlighted player character.

Note that, hereinafter, the player character 26 (27) belonging to the same team which is not the highlighted player character is referred to as “fellow player character”. The fellow player character behaves according to data for controlling the behavior of the fellow player character (for example, artificial intelligence (AI)).

Also in the computer team, any one of the eleven player characters 27 belonging to the computer team is set as the “highlighted player character (selected player character)”. Further, also in the computer team, the highlighted player character is switched over among the player characters 27 belonging to the computer team under a predetermined condition.

In the case of the computer team, the switching and the behavior of the highlighted player character are controlled according to data (for example, artificial intelligence (AI)) for controlling the switching and the behavior of the highlighted player character. Meanwhile, the behavior of the fellow player character is controlled according to data (for example, artificial intelligence (AI)) for controlling the behavior of the fellow player character. Note that the data for controlling the behavior of the fellow player character of the computer team may be the same as or different from the data for controlling the behavior of the fellow player character of the user team.

Note that, hereinafter, the data for controlling the switching and the behavior of the highlighted player character of the computer team is referred to as “highlighted player control data”, and the data for controlling the behavior of the fellow player character is referred to as “fellow player control data”.

### Regarding Generation of Highlighted Player Control Data

The behavior control data generation system 1 generates such highlighted player control data as to allow the execution of the control of the switching and the behavior of the highlighted player character belonging to the computer team as if a person (for example, skilled game player) performs the control.

The above-mentioned behavior control data generation device 10 includes a function of the game device for executing the game. In the case of this embodiment, on the behavior control data generation device 10, by having the skilled game player operate the user team to play the game, play data of the skilled player is acquired, and the highlighted player control data is generated based on the play data. That is, the highlighted player control data that reflects a tendency of a game operation performed by the skilled player is generated. Then, by having the switching and the behavior of the highlighted player character of the computer team controlled by using the highlighted player control data, the control of the switching and the behavior of the highlighted player character of the computer team is executed as if being performed by the skilled player.

Hereinafter, technology for generating the above-mentioned highlighted player control data is described.

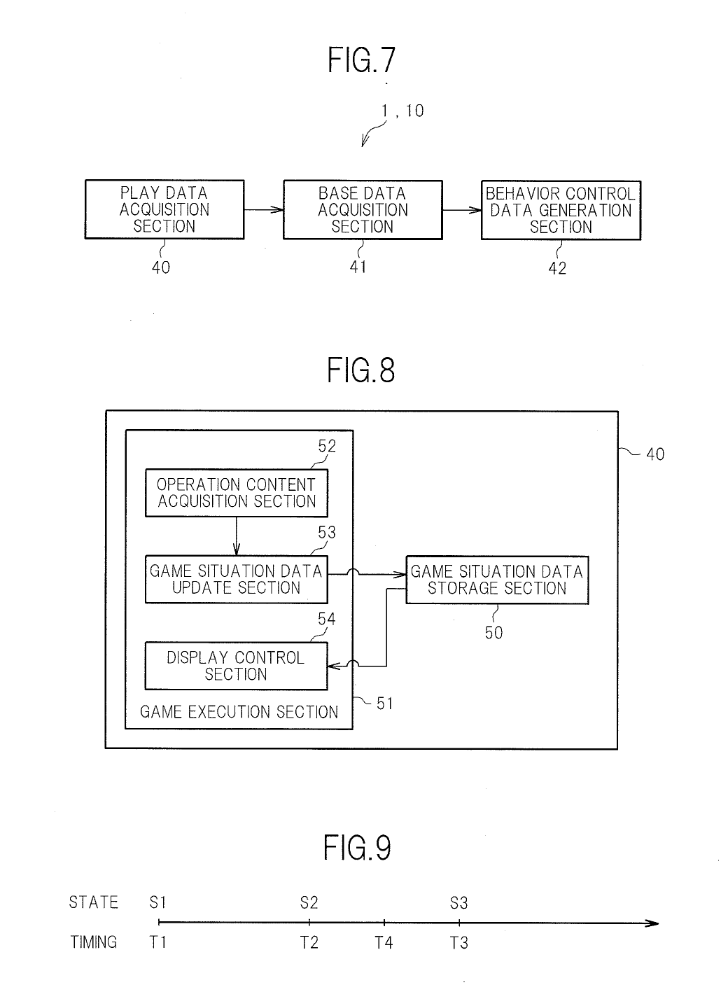

FIG. 7 is a functional block diagram illustrating functions implemented in the behavior control data generation system 1. As illustrated in FIG. 7, the behavior control data generation system 1 includes a play data acquisition section 40, a base data acquisition section 41, and a behavior control data generation section 42. The play data acquisition section 40, the base data acquisition section 41, and the behavior control data generation section 42 are implemented on the behavior control data generation device 10.

The play data acquisition section 40 is implemented mainly by, for example, the control unit 11 and the main memory unit 12. The play data acquisition section 40 acquires the play data for a case where a person plays the game configured such that the plurality of character objects or the plurality of character object groups perform a competition using the moving object by operating any one of the character objects or any one of the character object groups. The “play data” includes: data regarding state changes of the plurality of character objects or the plurality of character object groups and state changes of the moving object; and the data regarding the operation performed by the person.

For example, in the case of generating the highlighted player control data for the above-mentioned soccer game, the play data acquisition section 40 acquires the play data of the case where the person (for example, skilled game player) operates the user team to play the soccer game. For example, the play data includes the following data:
(a) data regarding changes in state (for example, positions) of the respective dynamic objects; and
(b) data regarding the game operation performed by an operator of the user team.

Note that the term “dynamic object” represents an object that changes in position and orientation within the game space 20, and the “dynamic objects” include the player characters 26 belonging to the user team, the player characters 27 belonging to the computer team, and the ball 24.

In the case of this embodiment, the play data acquisition section 40 includes functional blocks for executing the game, and acquires the play data by, for example, having the skilled game player or the like play the game. FIG. 8 is a diagram illustrating an example of the functional blocks included in the play data acquisition section 40. The play data acquisition section 40 illustrated in FIG. 8 includes a game situation data storage section 50 and a game execution section 51.

The game situation data storage section 50 is implemented by, for example, the main memory unit 12, and stores game situation data indicating a current situation of the game. For example, the game situation data includes the following data:
(a) state data (for example, position, orientation, posture, moving direction, and moving velocity within the game space 20, and type of behavior) on each of the player characters 26 and 27;
(b) state data (for example, position, moving direction, and moving velocity within the game space 20) on the ball 24;
(c) halfway result data; and
(d) elapsed time data.

Note that the state data on the player character 26 (27) includes data indicating whether or not the player character 26 (27) is set as the highlighted player character and data indicating whether or not the player character 26 (27) is in possession of the ball 24. Further, the halfway result data is data indicating a halfway result of a match. For example, the halfway result data is data indicating the number of occurrences of the scoring event for each team until a current time point. The elapsed time data is data indicating, for example, an elapsed time since the start of the match.

The game execution section 51 is implemented mainly by, for example, the control unit 11. As illustrated in FIG. 8, the game execution section 51 includes an operation content acquisition section 52, a game situation data update section 53, and a display control section 54. The operation content acquisition section 52 acquires contents of the operation performed by using the game controller 30. The game situation data update section 53 updates the game situation data based on a result of the acquisition performed by the operation content acquisition section 52. For example, the state of the dynamic objects (player characters 26 and 27 and the ball 24) is updated. The display control section 54 generates the game screen based on the game situation data, and displays the game screen onto the display unit 16.

Note that, hereinabove, the description is made on the assumption that the play data is acquired by having the skilled game player or the like play the game on the behavior control data generation device 10. However, the skilled game player or the like may be allowed to play the game on a game device provided separately from the behavior control data generation device 10.

That is, the play data acquisition section 40 may acquire the play data of the case where the skilled game player or the like plays the game on a game device provided separately from the behavior control data generation device 10. In this case, the play data acquisition section 40 may receive the play data via a communication network (for example, a LAN or/and the Internet), or may read the play data from an information storage medium (for example, optical disk) on which the play data is recorded. Note that, in this case, the game situation data storage section 50 and the game execution section 51 illustrated in FIG. 8 are implemented on the game device provided separately from the behavior control data generation device 10.

The base data acquisition section 41 and the behavior control data generation section 42 are implemented mainly by, for example, the control unit 11. Based on the data acquired by the play data acquisition section 40, the base data acquisition section 41 acquires base data, which is used for generating the behavior control data used for controlling the behavior of the character object or the character object group operated by the computer. The behavior control data generation section 42 generates the behavior control data based on the base data acquired by the base data acquisition section 41.

In particular, the base data acquisition section 41 acquires a combination of operation data and the state data as the base data. The operation data is related to the operation performed by the person between a first time and a second time. The state data is related to the state of the plurality of character objects or the plurality of character object groups at the first time and the state of the moving object at the first time. The first time corresponds to a collision between the moving object and any one of predetermined objects located within the game space. The second time corresponds to a subsequent collision between the moving object and any one of the predetermined objects located within the game space. Here, the any one of the predetermined objects that collides with the moving object in the collision corresponding to the first time may be the same object as or a different object from the any one of the predetermined objects that collides with the moving object in the collision corresponding to the second time.

For example, the “predetermined objects” include at least one of the character object and the athletic equipment object. Note that the “athletic equipment object” is an object representing equipment (which excludes a moving object such as a ball or a puck) used for a competition. In the case of the above-mentioned soccer game, the player characters 26 and 27 correspond to the “character objects”, and the goals 25a and 25b correspond to the “athletic equipment objects”.

In the case of this embodiment, the base data acquisition section 41 acquires the base data used for generating the behavior control data used for controlling the behavior of the computer team based on the play data acquired by the play data acquisition section 40. In the case of this embodiment, the highlighted player control data corresponds to the “behavior control data”.

First, an outline of operations of the base data acquisition section 41 and the behavior control data generation section 42 is described.

The person who plays a soccer game generally performs the game operation in consideration of the state of the respective player characters 26 and 27 and the ball 24. Therefore, with such a configuration that, in a case where the state of the player characters 26 and 27 and the ball 24 becomes a given state, the computer team is subjected to the same game operation as the game operation performed by, for example, the skilled game player in a state the same as or similar to the given state, the computer team is operated by the computer as if being operated by, for example, the skilled game player.

Therefore, in this embodiment, the base data acquisition section 41 acquires as the base data a combination of data indicating the state of the dynamic objects (player characters 26 and 27 and ball 24) at a given time in the case where the person (for example, skilled game player) plays the soccer game by operating the user team, and data indicating the game operation performed by the person within a given period from the given time. Then, the behavior control data generation section 42 generates the highlighted player control data based on the base data.

Incidentally, in the case of acquiring the base data as described above, points as described below need to be made aware of. Hereinafter, the points to be aware of are described by referring to FIG. 9. Note that, in FIG. 9, a state S1 represents the state of the dynamic objects (player characters 26 and 27 and ball 24) at a time T1, a state S2 represents the state of the dynamic objects at a time T2, and a state S3 represents the state of the dynamic objects at a time T3.

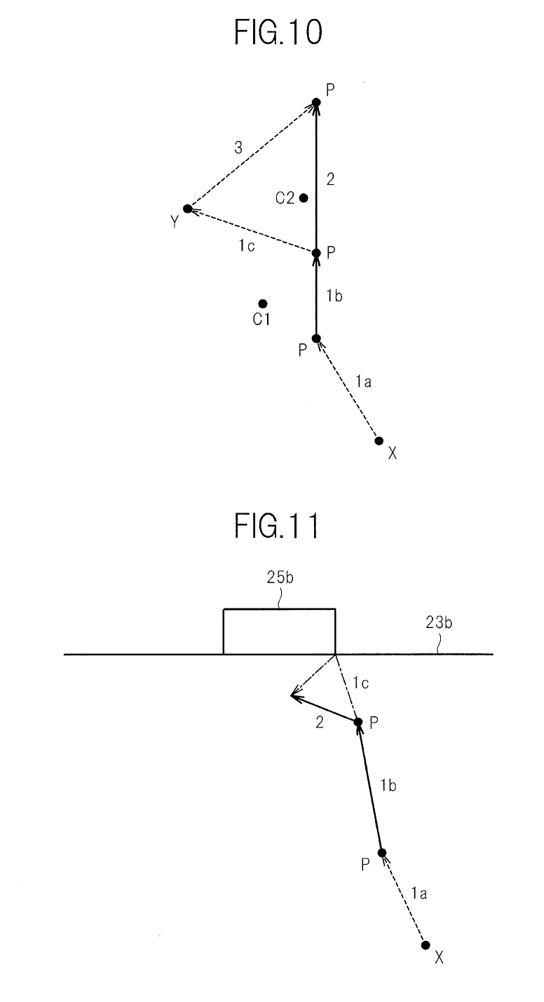

Here, a scene as described below is assumed. FIG. 10 is a diagram for describing the scene assumed here. In FIG. 10, a reference letter “P” indicates a highlighted player character belonging to the user team, and reference letters “X” and “Y” indicate fellow player characters belonging to the user team. In FIG. 10, reference letters “C1” and “C2” indicate the player characters 27 belonging to the computer team. Further, the solid arrows indicate that the highlighted player character P performs the movement action (including dribbling action), and the dotted arrows indicate that a pass is executed.
(1) After the highlighted player character P of the user team receives a pass from the fellow player character X at the time T1 (1a), the operator of the user team causes the highlighted player character P to move to a position that allows a pass to the fellow player character Y to be successful (1b), and further causes the highlighted player character P to execute the pass to the fellow player character Y (1c).
(2) After the fellow player character Y receives the pass from the highlighted player character P of the user team at the time T2, the operator of the user team causes the highlighted player character P to move to a position that allows a pass from the fellow player character Y to be successful.
(3) The pass from the fellow player character Y to the highlighted player character P of the user team is executed, and then, the highlighted player character P of the user team receives the pass from the fellow player character Y at the time T3.

In the scene as described above, the game operation performed during a period from the time T1 until the time T2 is a game operation that aims to successfully make a pass to the fellow player character Y. Further, the game operation performed during a period from the time T2 until the time T3 is a game operation that aims to successfully receive the pass from the fellow player character Y. That is, the aim of the game operation changes before and after the time T2 at which the pass to the fellow player character Y is successfully performed.

Here, a case where a combination of the state S1 at the time T1 and a series of game operations performed during a period from the time T1 until a time T4 between the time T2 and the time T3 is acquired as the base data is assumed. In this case, a plurality of game operations performed with separate aims are acquired as the series of game operations. In a case where the control related to the highlighted player character of the computer team is executed based on the highlighted player control data generated based on the base data as described above, such a problem as described below occurs.

In this case, the state of the dynamic objects (player characters 26 and 27 and ball 24) becomes a state the same as or similar to the state S1, and the same game operation as the game operation performed during the period from the time T1 until the time T4 is performed by the computer. In this case, by performing the same game operation as the game operation performed during the period from the time T1 until the time T2, the highlighted player character of the computer team executes a pass to the fellow player character. However, in this case, irrespective of whether or not the pass is successful, the game operation performed during a period from the time T2 until the time T4 (game operation to be executed in the case where the pass is successful) is executed. As a result, the behavior of the highlighted player character of the computer team becomes unnatural if the pass fails.

Further, a scene as described below is assumed. FIG. 11 is a diagram for describing the scene assumed here. Note that, in FIG. 11, the solid arrows, the dotted arrow, and the reference letters P and X are the same as those of FIG. 10. The alternate long and short dashed arrow indicates the movement of the ball 24 in a case where a shot is executed.
(1) After the highlighted player character P of the user team receives a pass from the fellow player character X at the time T1 (1a), the operator of the user team causes the highlighted player character P to move to a position suitable for shooting (1b), and further causes the highlighted player character P to execute a shot (1c).
(2) The ball 24 hits a goal post at the time T2, and hence the operator of the user team causes the highlighted player character P to move toward the ball 24.
(3) After that, the highlighted player character P of the user team is in possession of the ball 24 at the time T3.

In the scene as described above, the game operation performed during the period from the time T1 until the time T2 is a game operation that aims to cause the highlighted player character to execute a shot. Further, the game operation performed during a period from the time T2 until the time T3 is a game operation that aims to cause the highlighted player character to be in possession of the ball 24 that has hit the goal post. That is, the aim of the game operation changes before and after the time T2 at which the ball 24 hits the goal post.

Here, the case where a combination of the state S1 at the time T1 and the series of game operations performed during the period from the time T1 until the time T4 is assumed. Also in this case, a plurality of game operations performed with separate aims are acquired as the series of game operations. In the case where the control related to the highlighted player character of the computer team is executed based on the highlighted player control data generated based on the base data as described above, such a problem as described below occurs.

In this case, the state of the dynamic objects (player characters 26 and 27 and ball 24) becomes a state the same as or similar to the state S1, and the same game operation as the game operation performed during the period from the time T1 until the time T4 is performed by the computer. In this case, by performing the same game operation as the game operation performed during the period from the time T1 until the time T2, the highlighted player character executes a shot. However, in this case, irrespective of whether or not the ball 24 hits the goal post, the game operation performed during the period from the time T2 until the time T4 (game operation to be executed in the case where the ball 24 hits the goal post) is executed. As a result, the behavior of the highlighted player character of the computer team becomes unnatural if the ball 24 does not hit the goal post (for example, if the shot is successful).

As described above, in the case where the combination of the state of the dynamic objects and the series of game operations are acquired as the base data, the behavior of the computer team (highlighted player character) may become unnatural if the plurality of game operations having different aims are acquired as the series of game operations. Therefore, it should be noted that the plurality of game operations having different aims may not be acquired as the series of game operations. In this respect, as described as follows, with the base data acquisition section 41 according to this embodiment, the plurality of game operations having different aims are prevented from being acquired as the series of game operations.

In the soccer game, the aim of the game operation often changes when the ball 24 hits the player character 26 or 27 or the goal 25a or 25b. By focusing on this point, the base data acquisition section 41 acquires as the base data a combination of data as described below:
(a) the operation data indicating the game operation performed by the operator of the user team between a first time corresponding to a collision (contact) between the ball 24 and the player character 26 or 27 or the goal 25a or 25b and a second time corresponding to the subsequent collision between the ball 24 and the player character 26 or 27 or the goal 25a or 25b; and
(b) reference state data related to a positioning state of the dynamic objects (player characters 26 and 27 and ball 24) at the first time.

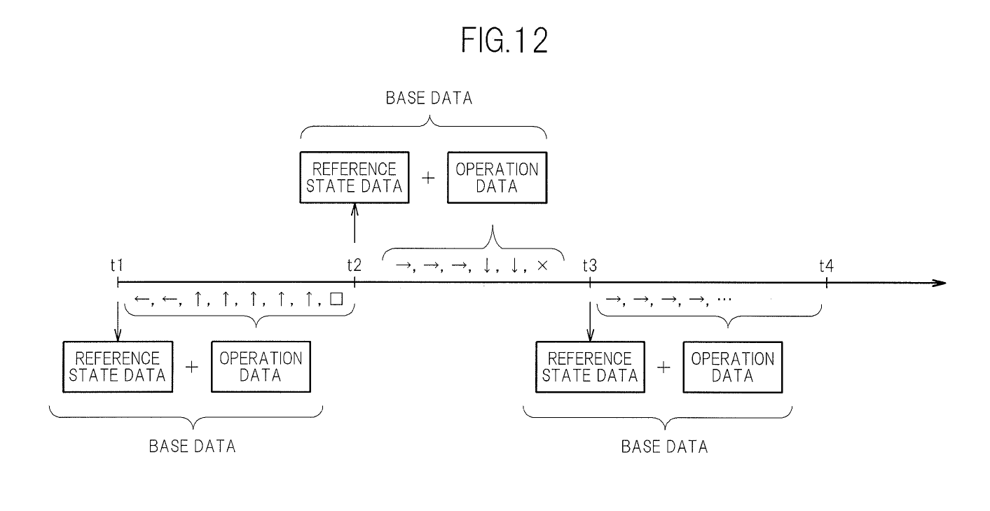

FIG. 12 is a diagram for describing an example of the base data. In FIG. 12, times t1, t2, t3, and t4 each represent a time at which the ball 24 hits the player character 26 or 27 or the goal 25a or 25b.

Further, in FIG. 12, the marks such as an arrow and a square indicate the game operation performed by the operator of the user team. Those marks correspond to the marks added to the respective buttons of the game controller 30. For example, the arrow of the upward direction corresponds to a depression operation of the upward direction portion 31U of the direction button 31. Further, for example, the square corresponds to the depression operation of the button 32X.

In such a case as illustrated in FIG. 12, the combination of the reference state data indicating the positioning state of the dynamic objects (player characters 26 and 27 and ball 24) at the time t1 and the operation data indicating the game operation performed by the operator of the user team during the period from the time t1 until the time t2 is acquired as the base data.

Further, the combination of the reference state data indicating the positioning state of the dynamic objects at the time t2 and the operation data indicating the game operation performed during the period from the time t2 until the time t3 is acquired as the base data.

Further, the combination of the reference state data indicating the positioning state of the dynamic objects at the time t3 and the operation data indicating the game operation performed during the period from the time t3 until the time t4 is acquired as the base data.

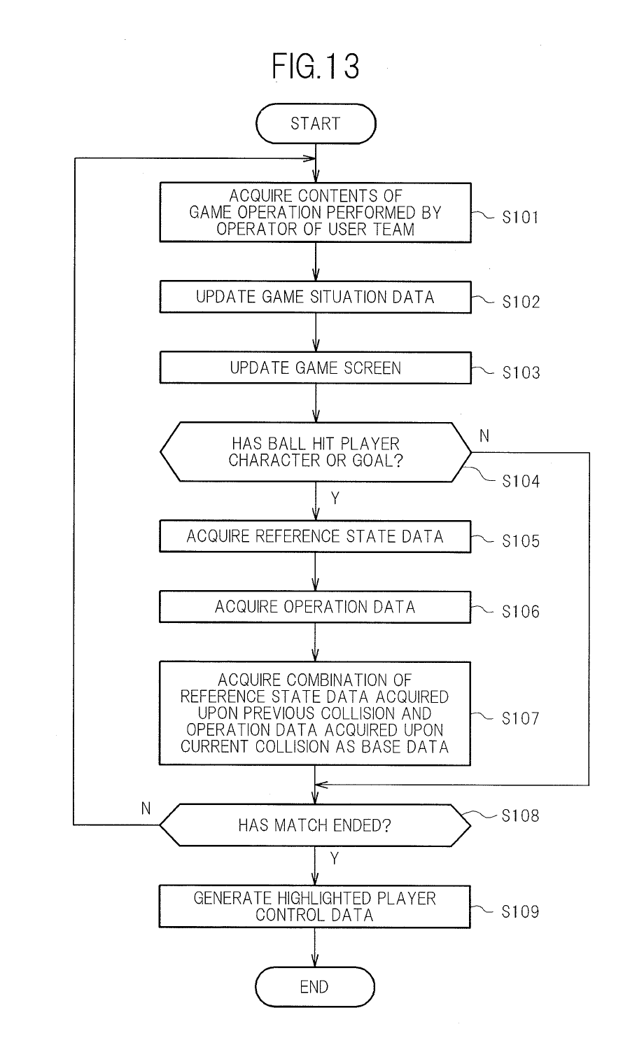

Then, the highlighted player control data is generated based on the base data thus acquired. Details thereof are described later with reference to Step S109 of FIG. 13.

FIG. 13 is a flowchart illustrating an example of processing executed by the behavior control data generation system 1. The processing illustrated in FIG. 13 is processing for generating the highlighted player control data. The control unit 11 executes the processing illustrated in FIG. 13 according to the program. The functional blocks illustrated in FIG. 7 are implemented by the control unit 11 executing the processing illustrated in FIG. 13.

Note that the processing illustrated in FIG. 13 is processing of acquiring the play data in the case where the person (for example, skilled game player) plays the game by operating the user team on the behavior control data generation device 10, and of generating the highlighted player control data based on the play data. Further, in the processing illustrated in FIG. 13, processing for acquiring the base data is executed in parallel with the person's playing the game by operating the user team.

In the processing illustrated in FIG. 13, the processing of Steps S101 to S108 is repeatedly executed every predetermined time (for example, 1/60^{th} of a second) during a period from the start of the match between the user team and the computer team until the end. Then, the processing of Step S109 is executed after the end of the match.

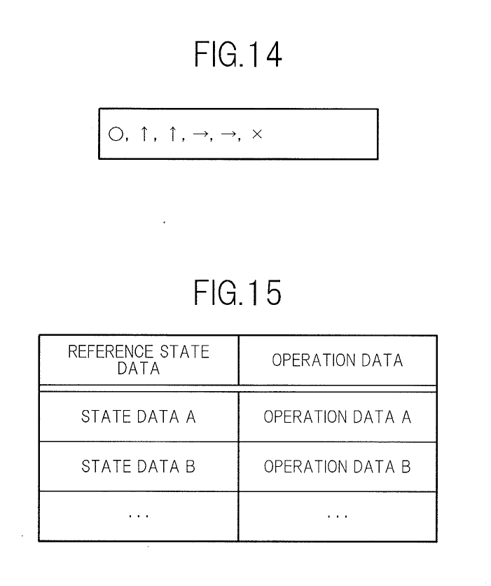

First, the processing of Steps S101 to S108 is described. As illustrated in FIG. 13, the control unit 11 (operation content acquisition section 52) acquires the contents of the game operation performed by the operator of the user team based on an operation signal supplied from the game controller 30 (S101). In this case, the control unit 11 additionally stores the acquired contents of the game operation into an operation storage area provided within the main memory unit 12. FIG. 14 is a diagram illustrating an example of the storage contents of the operation storage area. As illustrated in FIG. 14, an operation string indicating the game operation performed by the operator of the user team is stored in the operation storage area. Note that FIG. 14 illustrates a state in which the operation string is chronologically stored in a direction from the left to the right.

After that, the control unit 11 (game situation data update section 53) updates the game situation data (S102), and updates the game screen based on the updated game situation data (S103). In Step S102, for example, the state (for example, position) of the highlighted player character of the user team is updated based on the contents of the game operation acquired in Step S101. Further, for example, the states of the fellow player character of the user team, the highlighted player character and the fellow player character of the computer team, and the ball 24, are updated. Further, for example, a game event is caused to occur if a predetermined condition is satisfied. For example, if the ball 24 moves into the region within the goal 25b, the scoring event for the user team is caused to occur, and the halfway result data is updated. Besides, the elapsed time data is also updated.

After that, the control unit 11 (base data acquisition section 41) judges whether or not the ball 24 has hit the player character 26 or 27 or the goal 25a or 25b (S104). Note that general hit judgment processing (collision judgment processing) is used for the judgment as to whether or not the ball 24 has hit the player character 26 or 27 or the goal 25a or 25b.

If the ball 24 hits the player character 26 or 27 or the goal 25a or 25b, the control unit 11 (base data acquisition section 41) acquires the state data indicating the positioning state of the dynamic objects (player characters 26 and 27 and ball 24) as the reference state data, based on the game situation data (S105). The reference state data includes data indicating the positions of the respective player characters 26 and 27 and the ball 24, the orientations of the respective player characters 26 and 27, and the like. The reference state data is retained in the main memory unit 12.

Further, the control unit 11 (base data acquisition section 41) acquires the operation string stored in the operation storage area as the operation data (S106), and deletes the storage contents of the operation storage area. The storage contents of the operation storage area are thus deleted if the ball 24 hits the player character 26 or 27 or the goal 25a or 25b, and hence the operation string stored in the operation storage area indicates the “game operation performed by the operator of the user team during the period after the ball 24 hits the player character 26 or 27 or the goal 25a, or 25b until the ball 24 next hits the player character 26 or 27 or the goal 25a or 25b”.

Then, as illustrated in FIG. 12, the control unit 11 (base data acquisition section 41) acquires, as the base data, a combination of the reference state data acquired when the ball 24 previously collided with the player character 26 or 27 or the goal 25a or 25b and the operation data acquired when the ball 24 presently collides with the player character 26 or 27 or the goal 25a or 25b, and stores the base data into the auxiliary storage unit 13 (S107).

Note that the wording “reference state data acquired when the ball 24 previously collided” represents the reference state data acquired in the processing of Step S105 executed when the ball 24 previously collided with the player character 26 or 27 or the goal 25a or 25b. The wording “operation data acquired when the ball 24 presently collides” represents the operation data acquired in the processing of Step S106 executed when the ball 24 presently collides with the player character 26 or 27 or the goal 25a or 25b, in other words, the operation data acquired in the processing of Step S106 executed immediately before.

After the processing of Step S107 is executed, the control unit 11 judges whether or not the match between the user team and the computer team has ended (S108). Even if it is judged in Step S104 that the ball 24 has not hit the player character 26 or 27 or the goal 25a or 25b, the processing of Step S108 is executed.

If the match has not ended, the control unit 11 again executes the processing of Step S101. By repeated execution of the processing of Steps S105 to S107, the base data is accumulated in the auxiliary storage unit 13.

Meanwhile, if the match has ended, the control unit 11 (behavior control data generation section 42) generates the highlighted player control data based on the base data accumulated in the auxiliary storage unit 13 (S109).

Specifically, the control unit 11 generates the highlighted player control data by associating the reference state data and the operation data included in the base data. That is, the control unit 11 generates data in which the reference state data and the operation data are associated with each other as the highlighted player control data. For example, the control unit 11 generates neural network data in which the reference state data and the operation data are associated with each other. Further, for example, the control unit 11 generates Bayesian network data in which the reference state data and the operation data are associated with each other.

Note that, hereinafter, the description is made on the assumption that a table obtained by associating the reference state data and the operation data with each other is generated as the highlighted player control data. FIG. 15 illustrates an example of the highlighted player control data in this case.

### Regarding Use of Highlighted Player Control Data

The highlighted player control data generated as described above is supplied to the game device (for example, consumer game machine, arcade game machine, portable game machine, personal computer, mobile phone, or personal digital assistant) by using the information storage medium (for example, optical disk) or the communication network. Then, the highlighted player control data is used for controlling the behavior of the computer team in the soccer game executed on the game device.

Note that a hardware configuration of the game device is similar to the hardware configuration of the behavior control data generation device 10. Further, the game situation data storage section 50 and the game execution section 51 illustrated in FIG. 8 are implemented on the game device.

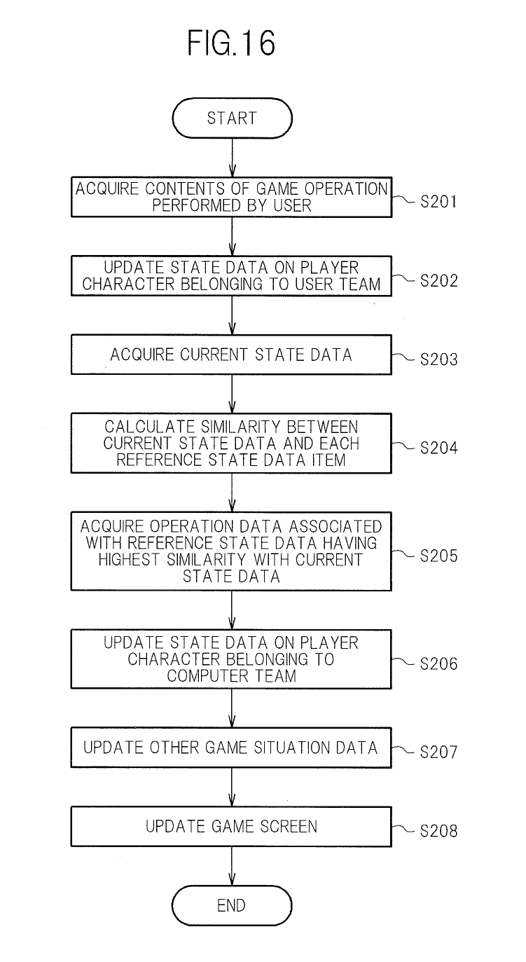

FIG. 16 is a diagram for describing how the highlighted player control data is used in the soccer game, and is a flowchart illustrating an example of processing executed by the game device for executing the soccer game every predetermined time (for example, 1/60^{th} of a second).

As illustrated in FIG. 16, a control unit of the game device acquires the contents of the game operation performed by the user based on the operation signal supplied from the game controller (S201). Then, the control unit updates the state data on the respective player characters 26 belonging to the user team (S202).

For example, if the button 33L is depressed, the highlighted player character of the user team is switched over to another player character 26 belonging to the user team. Further, for example, the state data (for example, position) on the highlighted player character of the user team is updated based on the contents of the game operation acquired in Step S201. For example, the position or the like of the highlighted player character of the user team is updated so that the highlighted player character moves in the direction corresponding to the depressed state of the direction button 31. Further, for example, if the button 32A is depressed, the posture or the like of the highlighted player character of the user team is updated so that the highlighted player character performs the passing action. Further, for example, the state data (for example, position) on the fellow player character of the user team is updated so that the fellow player character behaves based on the fellow player control data.

After that, the control unit acquires current state data indicating a current positioning state of the dynamic objects (player characters 26 and 27 and ball 24) (S203). Then, the control unit calculates a similarity between the current state data and each of the reference state data items included in the highlighted player control data (S204). In Step S204, for example, processing as described below is executed.

That is, first, a first feature vector representing a feature of the positioning state of the dynamic objects at a current time point is acquired based on the current state data. The term “feature vector” represents, for example, a vector having various kinds of information related to the positioning state of the dynamic objects as its components. The various kinds of information related to the positioning state of the dynamic objects include, for example, a distance between the ball 24 and the player character 26 or 27 closest to the ball 24, and a distance between the player character 26 or 27 in possession of the ball 24 and the goal 25a or 25b.

Further, a second feature vector representing a feature of the positioning state of the dynamic objects at a time point corresponding to the reference state data (time point at which the ball 24 collides with the player character 26 or 27 or the goal 25a or 25b) is acquired based on the reference state data. Then, an inner product value between the first feature vector and the second feature vector is acquired as the similarity between the current state data and the reference state data.

After the processing of Step S204 is executed, the control unit acquires the operation data (hereinafter, referred to as “operation data X”) associated with the reference state data having the highest similarity with the current state data (S205). Then, the control unit updates the state data on the player characters 27 belonging to the computer team based on the operation data X (S206).

For example, in the processing of Step S206, the operation data X is reproduced. The wording “the operation data X is reproduced” represents that the state data on the player character 27 belonging to the computer team is updated by assuming that the game operation indicated by the operation data X is performed on the computer team.

For example, if the game operation indicated by the operation data X includes the depression operation of the button 33L, the highlighted player character of the computer team is switched over to another player character 27 belonging to the computer team. Further, for example, if the game operation indicated by the operation data X includes the depression operation of the direction button 31, the position or the like of the highlighted player character of the computer team is updated so that the highlighted player character moves in the direction corresponding to the depressed state of the direction button 31. Further, for example, the game operation indicated by the operation data X includes the depression operation of the button 32A, the posture or the like of the highlighted player character of the computer team is updated so that the highlighted player character performs the passing action.

Note that, in the processing of Step S206, the state data (for example, position) on the fellow player character of the computer team is also updated so that the fellow player character behaves based on the fellow player control data.

After that, the control unit updates other game situation data (S207). Specifically, the state data on the ball 24 is updated. For example, if the ball 24 is kicked by any one of the player characters 26 (27), the moving direction or the like of the ball 24 is updated. Further, the halfway result data and the elapsed time data are also updated. After the processing of Step S207 is executed, the control unit updates the game screen (S208).

### SUMMARY

According to the behavior control data generation system 1 described above, it is possible to reflect an operation tendency of, for example, the skilled game player upon the behavior control data for controlling the behavior of the computer team in the soccer game. Then, by using the behavior control data, the computer team behaves as if being operated by the skilled player. As a result, the user can enjoy a virtual competition against the skilled player.

In particular, in the behavior control data generation system 1, the behavior control data is generated while preventing the plurality of game operations having different aims from being acquired as the series of game operations. If the behavior control data is generated after the plurality of game operations having different aims are acquired as the series of game operations, the behavior of the computer team becomes unnatural, as described above. In this respect, according to the behavior control data generation system 1, it is possible to prevent such an inconvenience from occurring.

### Modified Example

Note that the present invention is not limited to the embodiment described above.

(1) For example, the highlighted player control data may be generated based on the play data acquired in the case where the developer, a beginner, or a general user of the game plays the game by operating the user team.

(2) Further, for example, in Step S205 of FIG. 16, the operation data associated with the reference state data having the similarity with the current state data equal to or higher than a reference value (for example, 0.8) may be acquired instead of acquiring the operation data associated with the reference state data having the highest similarity with the current state data. However, in this aspect, if there are a plurality of reference state data items having the similarity with the current state data equal to or higher than the reference value, it is necessary to choose which reference state data item is used to acquire the operation data.

In this respect, in Modified Examples (2-1) to (2-4) described below, if there exist a plurality of reference state data items having a similarity with the current state data equal to or higher than the reference value, the most suitable operation data item is acquired from among a plurality of operation data items associated with the plurality of reference state data items.

(2-1) For example, the person who plays the soccer game tends to perform the game operation in consideration of a changing pattern of the positioning state of the dynamic objects (player characters 26 and 27 and ball 24) instead of performing the game operation in consideration of only the positioning state of the dynamic objects at one time point. Therefore, the game operation performed by the person changes according to the changing pattern of the positioning state of the dynamic objects. Therefore, by generating the highlighted player control data also in consideration of the changing pattern of the positioning state of the dynamic objects, it is possible to cause conduct of the computer team to become further closer to the conduct thereof in the case of being operated by the person.

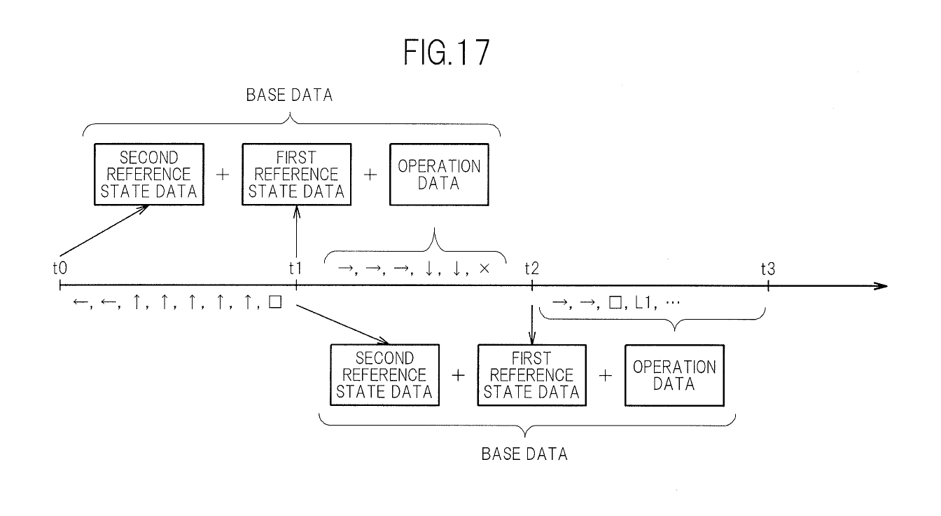

FIG. 17 is a diagram for describing an example of the base data according to Modified Example (2-1). As in FIG. 12, in FIG. 17, times t0, t1, t2, and t3 each represent a time at which the ball 24 hits the player character 26 or 27 or the goal 25a or 25b.

In the example illustrated in FIG. 17, for example, first reference state data indicating the positioning state of the dynamic objects (player characters 26 and 27 and ball 24) at the time t1 corresponding to the collision between the ball 24 and the player character 26 or 27 or the goal 25a or 25b is acquired. Further, the operation data indicating the game operation performed by the operator of the user team during the period between the time t1 and the time t2 corresponding to the subsequent collision between the ball 24 and the player character 26 or 27 or the goal 25a or 25b is acquired.

In addition, second reference state data indicating the positioning state of the dynamic objects at a time or period prior to the time t1 is acquired. In the example illustrated in FIG. 17, the state data indicating the positioning state of the dynamic objects at a time t0 corresponding to the previous collision between the ball 24 and the player character 26 or 27 or the goal 25a or 25b is acquired as the second reference state data.

In this manner, in Modified Example (2-1), a combination of the first reference state data indicating the positioning state of the dynamic objects at the time t1 (first time), the operation data indicating the game operation performed by the operator of the user team during the period between the time t1 (first time) and the time t2 (second time), and the second reference state data indicating the positioning state of the dynamic objects prior to the time t1 (first time) is acquired as the base data.

Next, processing executed in Modified Example (2-1) is described.

The processing for generating the highlighted player control data is the same as the processing illustrated in FIG. 13. However, as illustrated in FIG. 17, a combination of the second reference state data being the reference state data acquired in the processing of Step S105 executed upon the second previous collision, the first reference state data being the reference state data acquired in the processing of Step S105 executed upon the previous collision, and the operation data acquired in the processing of Step S106 executed upon the current collision, is acquired as the base data in Step S107, and the base data is accumulated in the auxiliary storage unit. Then, in Step S109, the highlighted player control data is generated based on the base data accumulated in the auxiliary storage unit. That is, as the highlighted player control data, data in which the second reference state data, the first reference state data, and the operation data that are included in the base data are associated with one another is generated. For example, the neural network or Bayesian network data in which the second reference state data, the first reference state data, and the operation data are associated with one another is generated.

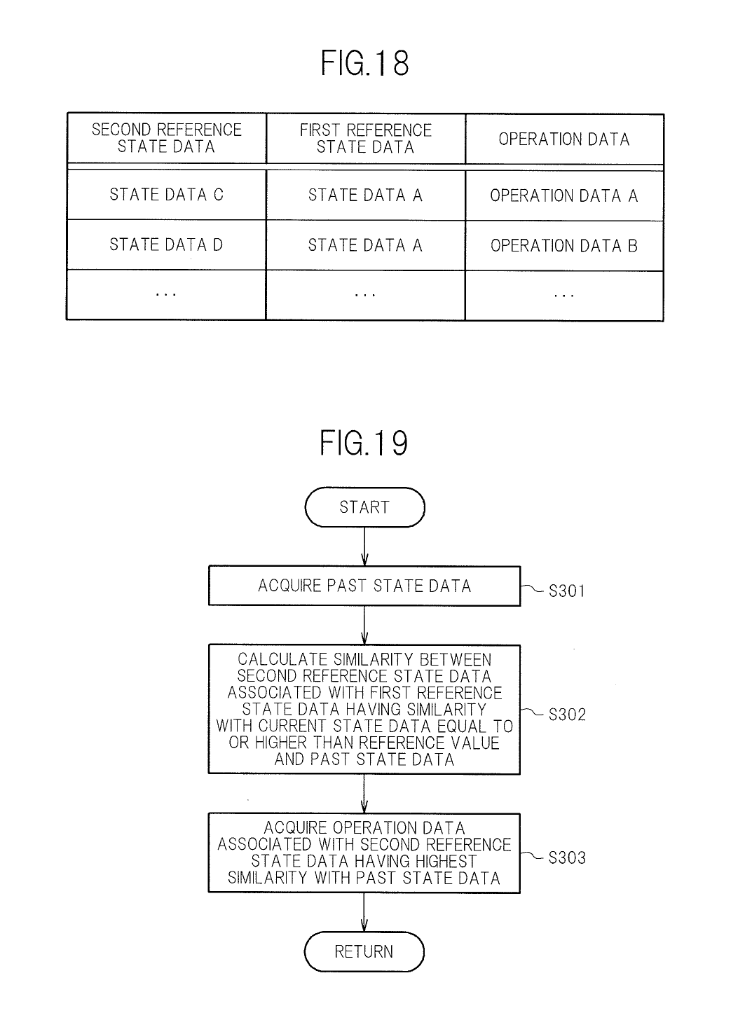

FIG. 18 is a diagram for describing an example of the highlighted player control data generated in Modified Example (2-1). The highlighted player control data illustrated in FIG. 18 is a table in which the second reference state data, the first reference state data, and the operation data that are included in the base data are associated with one another. For example, the example of FIG. 18 indicates that the game operation indicated by operation data A is performed on the highlighted player character of the computer team when the positioning state of the dynamic objects changes from the positioning state indicated by state data C to the positioning state indicated by state data A.

Processing executed by the game device in a case where the soccer game is executed by using the highlighted player control data illustrated in FIG. 18 is the same as the processing illustrated in FIG. 16. However, in this case, the game situation data obtained during a period from a predetermined time before until the current time is stored in the main memory unit (or auxiliary storage unit).

Further, in Step S204, the similarity between the current state data and each of the first reference state data items included in the highlighted player control data is calculated. In addition, if there exist a plurality of first reference state data items having a similarity with the current state data equal to or higher than the reference value, the processing of Steps S301 to S303 illustrated in FIG. 19 is executed instead of Step S205.

That is, as illustrated in FIG. 19, the control unit first acquires past state data indicating the positioning state of the dynamic objects (player characters 26 and 27 and ball 24) at a time point at which the previous collision occurred between the ball 24 and the player character 26 or 27 or the goal 25a or 25b (S301).

After that, the control unit calculates a similarity between the second reference state data associated with the first reference state data having the similarity with the current state data equal to or higher than the reference value and the past state data (S302). Then, the control unit acquires the operation data (operation data X) associated with the second reference state data having the highest similarity with the past state data (S303). Then, in Step S206 of FIG. 16, the state (for example, position) of the player character 27 belonging to the computer team is updated based on the operation data X.

In Modified Example (2-1), the game operation performed by the skilled game player or the like in the case where a changing pattern occurs that is the same as or similar to the changing pattern of the positioning state of the dynamic objects (player characters 26 and 27 and ball 24) during a period after the ball 24 hit the player character 26 or 27 or the goal 25a or 25b until the current time, is performed on the computer team. According to Modified Example (2-1), it is possible to cause the conduct of the computer team to become closer to the conduct thereof in the case of being operated by the skilled game player or the like.

(2-2) Further, for example, the person who plays the soccer game tends to perform the game operation that gives favorable results for the person themselves. Therefore, by generating the highlighted player control data also in consideration thereof, it is possible to cause the conduct of the computer team to become further closer to the conduct thereof in the case of being operated by the person.

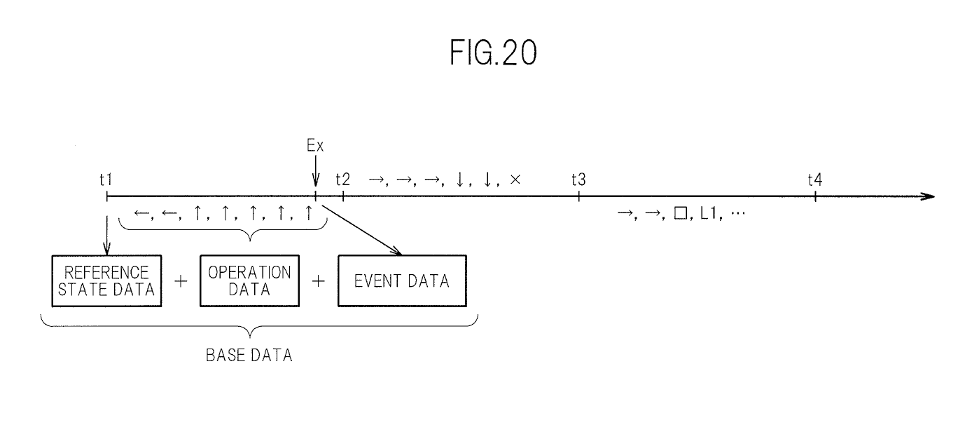

FIG. 20 is a diagram for describing an example of the base data according to Modified Example (2-2). As in FIG. 12, in FIG. 20, the times t1, t2, t3, and t4 each represent a time at which the ball 24 hits the player character 26 or 27 or the goal 25a or 25b.

In the example illustrated in FIG. 20, for example, the reference state data indicating the positioning state of the dynamic objects (player characters 26 and 27 and ball 24) at the time t1 corresponding to the collision between the ball 24 and the player character 26 or 27 or the goal 25a or 25b is acquired. Further, the operation data indicating the game operation performed by the operator of the user team during the period between the time t1 and the time t2 corresponding to the subsequent collision between the ball 24 and the player character 26 or 27 or the goal 25a or 25b is acquired.

In addition, event data for identifying a game event Ex that occurs after the time t1 is acquired. Here, the game event Ex is a game event related to the user team, and includes, for example, the scoring event, the corner kick event, and the goal kick event for the user team.

In this manner, in Modified Example (2-2), a combination of the reference state data indicating the positioning state of the dynamic objects at the time t1 (first time), the operation data indicating the game operation performed by the operator of the user team during the period between the time t1 (first time) and the time t2 (second time), and the event data for identifying the game event Ex that occurs after the time t1 (first time) is acquired as the base data.

Next, processing executed in Modified Example (2-2) is described.

The processing for generating the highlighted player control data is the same as the processing illustrated in FIG. 13. However, as illustrated in FIG. 20, a combination of the reference state data acquired in the processing of Step S105 executed upon the previous collision, the operation data acquired in the processing of Step S106 executed upon the current contact, and the event data indicating a game event that has occurred during a period from the previous collision until the current collision is acquired as the base data in Step S107, and the base data is accumulated in the auxiliary storage unit. Then, in Step S109, the highlighted player control data is generated based on the base data accumulated in the auxiliary storage unit. That is, as the highlighted player control data, data in which the reference state data, the operation data, and the event data that are included in the base data are associated with one another is generated. For example, the neural network or Bayesian network data in which the reference state data, the operation data, and the event data are associated with one another is generated.

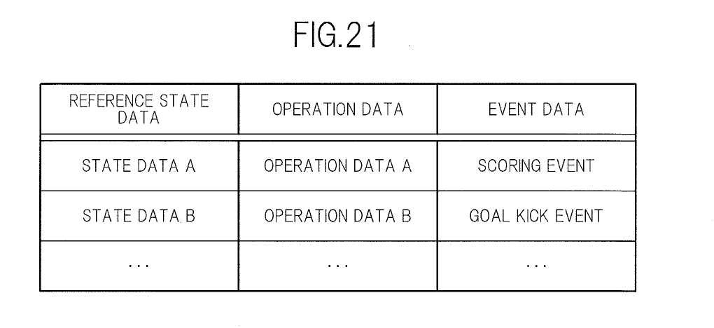

FIG. 21 is a diagram illustrating an example of the highlighted player control data generated in Modified Example (2-2). The highlighted player control data illustrated in FIG. 21 is a table in which the reference state data, the operation data, and the event data that are included in the base data are associated with one another.

Processing executed by the game device in a case where the soccer game is executed by using the highlighted player control data illustrated in FIG. 21 is also the same as the processing illustrated in FIG. 16. However, in Step S205, if there exist a plurality of reference state data items having a similarity with the current state data that is equal to or higher than the reference value, the operation data associated with a predetermined game event (for example, game event beneficial to the computer team) is acquired from among a plurality of operation data items associated with the plurality of reference state data items.

Here, the wording “game event beneficial to the computer team” represents, for example, the scoring event or the corner kick event for the computer team. For example, if there exists the operation data associated with the event data indicating the scoring event, that operation data is acquired. Further, for example, if the operation data associated with the event data indicating the scoring event does not exist, and if the operation data associated with the event data indicating the corner kick event exists, that operation data is acquired.

Then, in Step S206, the state of the player character 27 belonging to the computer team is updated based on the operation data (operation data X) acquired in Step S203.

According to Modified Example (2-2), for example, such a game operation as to cause the occurrence of the game event that is beneficial to the computer team is performed on the computer team.

(2-3) Further, for example, the person who plays the soccer game tends to perform the game operation in consideration of not only the positioning state of the dynamic objects (player characters 26 and 27 and ball 24) but also a progress status (for example, elapsed time) of the match. Therefore, the game operation performed by the person changes depending on the progress status of the match.

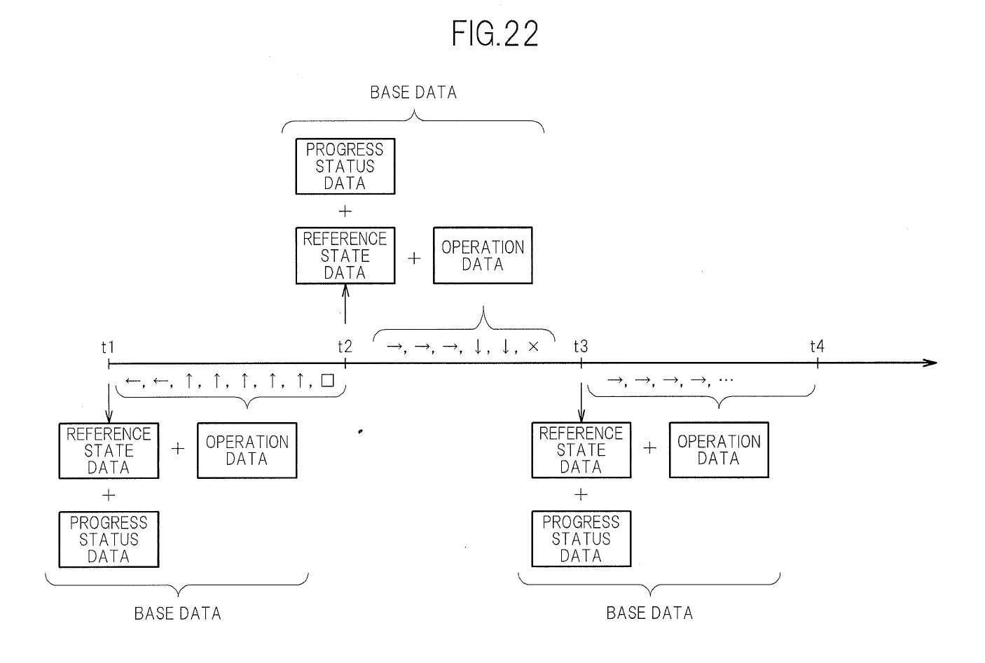

Therefore, by generating the highlighted player control data also in consideration of the progress status of the match, it is possible to cause the conduct of the computer team to become further closer to the conduct thereof in the case of being operated by the person. FIG. 22 is a diagram for describing an example of the base data according to Modified Example (2-3). As in FIG. 12, in FIG. 22, the times t1, t2, t3, and t4 each represent a time at which the ball 24 hits the player character 26 or 27 or the goal 25a or 25b.

In the example illustrated in FIG. 22, for example, the reference state data indicating the positioning state of the dynamic objects (player characters 26 and 27 and ball 24) at the time t1 corresponding to the collision between the ball 24 and the player character 26 or 27 or the goal 25a or 25b is acquired. Further, the operation data indicating the game operation performed by the operator of the user team during the period between the time t1 and the time t2 corresponding to the collision between the ball 24 and the player character 26 or 27 or the goal 25a or 25b is acquired.

In addition, progress status data regarding the progress status of the match at the time t1 is acquired. The progress status data represents, for example, data indicating the elapsed time of the match at the time t1.

Next, processing executed in Modified Example (2-3) is described.

The processing for generating the highlighted player control data is the same as the processing illustrated in FIG. 13. However, as illustrated in FIG. 22, a combination of the reference state data acquired in the processing of Step S105 executed upon the previous collision, the operation data acquired in the processing of Step S106 executed upon the current collision, and the progress status data indicating a progress status (for example, elapsed time) of the match at the time of the previous collision is acquired as the base data in Step S107, and the base data is accumulated in the auxiliary storage unit. Then, in Step S109, the highlighted player control data is generated based on the base data accumulated in the auxiliary storage unit. That is, as the highlighted player control data, data in which the reference state data, the operation data, and the progress status data that are included in the base data are associated with one another is generated. For example, the neural network or Bayesian network data in which the reference state data, the operation data, and the progress status data are associated with one another is generated.

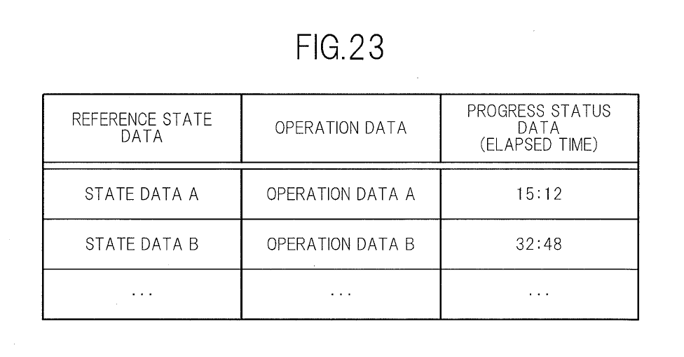

FIG. 23 is a diagram illustrating an example of the highlighted player control data generated in Modified Example (2-3). The highlighted player control data illustrated in FIG. 23 is a table in which the reference state data, the operation data, and the progress status data (elapsed time) that are included in the base data are associated with one another.

Processing executed by the game device in a case where the soccer game is executed by using the highlighted player control data illustrated in FIG. 23 is also the same as the processing illustrated in FIG. 16.

However, in Step S205, if there exist a plurality of reference state data items having a similarity with the current state data equal to or higher than the reference value, any one of the plurality of reference state data items is selected based on a result of comparing the progress status (elapsed time) indicated by the progress status data associated with the plurality of reference state data items with the current progress status (elapsed time at the current time point). For example, the reference state data associated with the progress status data having the smallest difference from the current progress status is selected. Then, the operation data associated with the selected reference state data is acquired.

Then, in Step S206, the state of the player character 27 belonging to the computer team is updated based on the operation data (operation data X) acquired in Step S205.

According to Modified Example (2-3), the game operation performed by the skilled game player or the like in a case of a progress status that is the same as or similar to the current progress status of the match is performed on the computer team. According to Modified Example (2-3), it is possible to cause the conduct of the computer team to become further closer to the conduct thereof in the case of being operated by the person.

(2-4) Further, for example, the person who plays the soccer game tends to perform the game operation in consideration of not only the positioning state of the dynamic objects (player characters 26 and 27 and ball 24) but also a halfway result of the match (for example, match result at the current time point). Therefore, the game operation performed by the person changes depending on the halfway result of the match. Therefore, by generating the highlighted player control data also in consideration of the halfway result of the match, it is possible to cause the conduct of the computer team to become further closer to the conduct thereof in the case of being operated by the person.

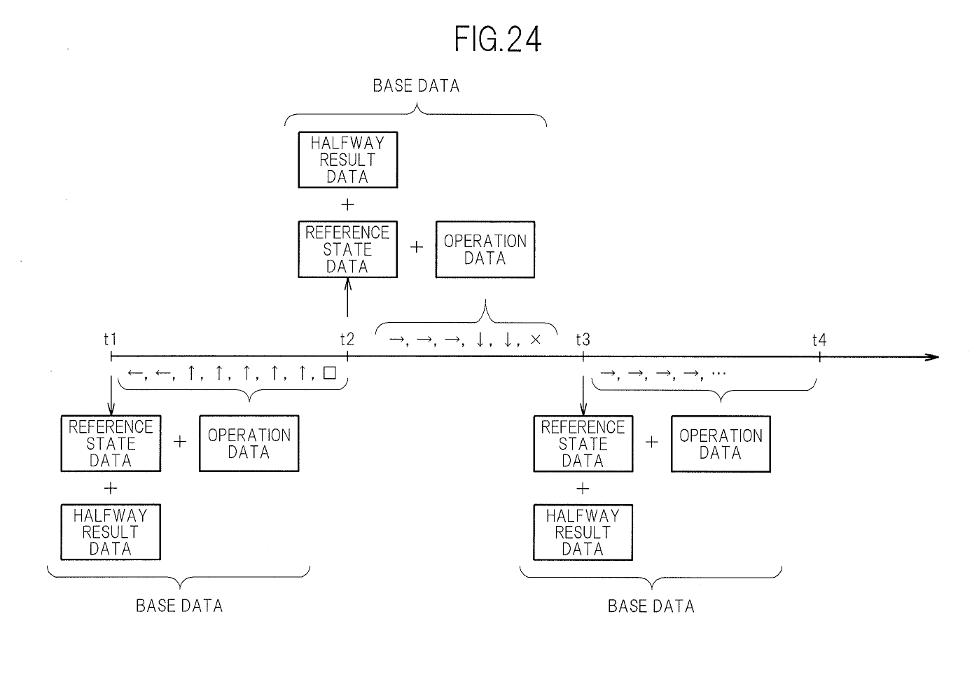

FIG. 24 is a diagram for describing an example of the base data according to Modified Example (2-4). As in FIG. 12, in FIG. 24, the times t1, t2, t3, and t4 each represent a time at which the ball 24 hits the player character 26 or 27 or the goal 25a or 25b.

In the example illustrated in FIG. 24, for example, the reference state data indicating the positioning state of the dynamic objects at the time t1 corresponding to the collision between the ball 24 and the player character 26 or 27 or the goal 25a or 25b is acquired. Further, the operation data indicating the game operation performed by the operator of the user team during the period between the time t1 and the time t2 corresponding to the subsequent collision between the ball 24 and the player character 26 or 27 or the goal 25a or 25b is acquired.

In addition, the halfway result data regarding the halfway result of the match at the time t1 is acquired. The halfway result data is data indicating the result of the match at the time t1, and includes, for example, data indicating “win”, “lose”, or “draw”. Note that the halfway result data may include data indicating a difference in score.

Next, processing executed in Modified Example (2-4) is described.

The processing for generating the highlighted player control data is the same as the processing illustrated in FIG. 13. However, as illustrated in FIG. 24, a combination of the reference state data acquired in the processing of Step S105 executed upon the previous collision, the operation data acquired in the processing of Step S106 executed upon the current collision, and the halfway result data indicating the halfway result of the match at the time of the previous collision is acquired as the base data in Step S107, and the base data is accumulated in the auxiliary storage unit. Then, in Step S109, the highlighted player control data is generated based on the base data accumulated in the auxiliary storage unit. That is, as the highlighted player control data, data in which the reference state data, the operation data, and the halfway result data that are included in the base data are associated with one another is generated. For example, the neural network or Bayesian network data in which the reference state data, the operation data, and the halfway result data are associated with one another is generated.

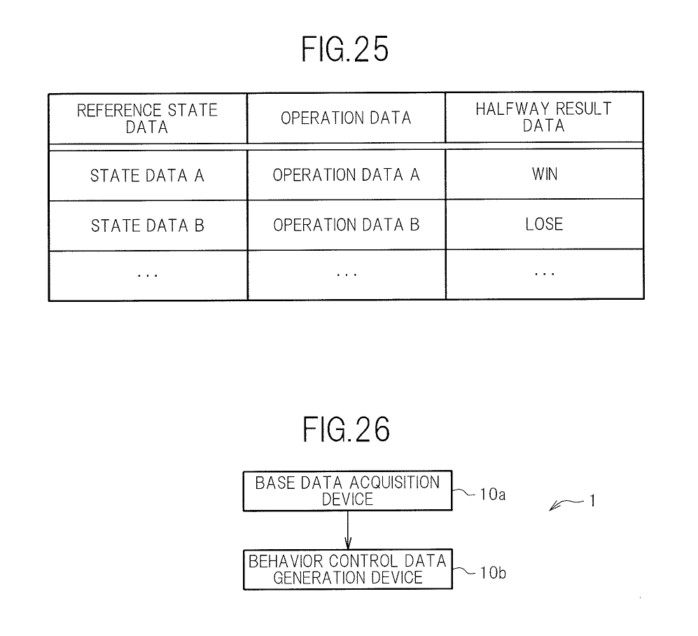

FIG. 25 is a diagram illustrating an example of the highlighted player control data generated in Modified Example (2-4). The highlighted player control data illustrated in FIG. 25 is a table in which the reference state data, the operation data, and the halfway result data that are included in the base data are associated with one another.

Processing executed by the game device in a case where the soccer game is executed by using the highlighted player control data illustrated in FIG. 25 is the same as the processing illustrated in FIG. 16.

However, in Step S205, if there exist a plurality of reference state data items having a similarity with the current state data equal to or higher than the reference value, any one of the plurality of reference state data items is selected based on a result of comparing the halfway result indicated by the halfway result data associated with the plurality of reference state data items with the current halfway result. For example, the reference state data associated with the halfway result data indicating the same halfway result as the current halfway result is selected. Then, the operation data associated with the selected reference state data is acquired.

Then, in Step S206, the state of the player character 27 belonging to the computer team is updated based on the operation data (operation data X) acquired in Step S205.

According to Modified Example (2-4), the game operation performed by the skilled game player or the like in a case of a halfway result that is the same as or similar to the current halfway result of the match is performed on the computer team. According to Modified Example (2-4), it is possible to cause the conduct of the computer team to become further closer to the conduct thereof in the case of being operated by the person.

(3) Further, for example, in the processing illustrated in FIG. 13, the acquisition of the base data is executed in parallel with the playing of the game performed by the skilled game player or the like. However, the acquisition of the base data may be executed after the game (match) has ended. However, in this case, data for reproducing a game situation during the match needs to be stored in the auxiliary storage unit 13. That is, the game situation data at each time during the match needs to be stored in the auxiliary storage unit 13. In addition, data indicating the game operation performed by the operator of the user team at each time during the match needs to be stored in the auxiliary storage unit 13. Note that in the case of Modified Example (2-3), data indicating the progress status at each time during the match needs to be stored in the auxiliary storage unit 13. Further, in the case of Modified Example (2-4), data indicating the halfway result at each time during the match needs to be stored in the auxiliary storage unit 13.

(4) Further, for example, the behavior control data generation system 1 may include a plurality of information processing devices. For example, as illustrated in FIG. 26, the behavior control data generation system 1 may include a base data acquisition device 10a and a behavior control data generation device 10b. The base data acquisition device 10a is an information processing device for executing the acquisition of the base data, and has the same hardware configuration as the behavior control data generation device 10 illustrated in FIG. 1. Further, the behavior control data generation device 10b is an information processing device for executing the generation of the behavior control data, and has the same hardware configuration as the behavior control data generation device 10 illustrated in FIG. 1. Note that, in this case, the play data acquisition section 40 and the base data acquisition section 41 are implemented on the base data acquisition device 10a, and the behavior control data generation section 42 is implemented on the behavior control data generation device 10b.

(5) Further, for example, at least one of the acquisition of the base data and the generation of the highlighted player control data (behavior control data) may be executed on the game device possessed by a general user. That is, at least one of the base data acquisition section 41 (and the play data acquisition section 40) and the behavior control data generation section 42 may be implemented on the game device (information processing device) possessed by the general user.

For example, on the game device, the play data of the case where the user plays the game by operating the user team may be acquired, and the acquisition of the base data and the generation of the highlighted player control data may be executed based on the play data. Alternatively, on the game device, the base data may be acquired based on the play data acquired in the case where the user plays the game by operating the user team, and the base data may be supplied to the behavior control data generation system 1.

Alternatively, the play data on the skilled game player or the like may be supplied to the game device, and on the game device, the acquisition of the base data and the generation of the highlighted player control data may be executed based on the supplied play data. Alternatively, the base data acquired based on the play data on the skilled game player or the like may be supplied to the game device, and on the game device, the generation of the highlighted player control data may be executed based on the supplied base data.

(6) Further, for example, the fellow player control data for controlling the behavior of the fellow player character may be generated based on the base data in the same manner as the highlighted player control data.

(7) Further, for example, a plurality of player characters 26 among the player characters 26 belonging to the user team may be set as the highlighted player characters. In the same manner, a plurality of player characters 27 among the player characters 27 belonging to the computer team may be set as the highlighted player characters.

Further, for example, a plurality of users may operate the user team in cooperation. Further, a match between soccer teams both of which are operated by users or a match between soccer teams both of which are operated by computers may be performed in the soccer game.

(8) Further, for example, the present invention may be applied to a sports game other than the soccer game as long as the sports game is a game configured such that a plurality of character object groups (for example, teams) perform a competition using a moving object (for example, object representing a ball or a puck). Note that, for example, in a case of the game of a sport such as ice hockey which is performed within a region surrounded by walls, the base data acquisition section 41 may execute the acquisition of the base data in consideration of not only the collision between the moving object (object representing a puck) and the character object or the athletic equipment object, but also the collision between the moving object (object representing a puck) and a wall object.

Further, for example, the present invention may also be applied to not only a game configured such that a competition using the moving object (for example, object representing a ball or shuttlecock) is performed between the character object groups, but also a game configured such that a competition using the moving object is performed between the character objects. For example, the present invention may also be applied to the game of a ball sport (for example, tennis, table tennis, or badminton) performed between two character objects. In this case, it is judged in Step S104 of FIG. 13 whether or not the object representing a ball or a shuttlecock has hit an object (athletic equipment object) representing a racket or an object (athletic equipment object) representing a net.

(9) While there have been described what are at present considered to be certain embodiments of the invention, it will be understood that various modifications may be made thereto, and it is intended that the appended claims cover all such modifications as fall within the true spirit and scope of the invention.

What is claimed is:

1. A behavior control data generation system, comprising:
play data acquisition means for acquiring
data related to change in state of a plurality of character objects or a plurality of character object groups and a moving object in a case where a person plays a game by operating any one of the plurality of character objects or any one of the plurality of character object groups, the game being configured such that the plurality of character objects or the plurality of character object groups perform a competition using the moving object within a game space, and
data related to an operation performed by the person in the case where the person plays the game by operating the any one of the plurality of character objects or the any one of the plurality of character object groups;
base data acquisition means for acquiring base data based on the data acquired by the play data acquisition means, the base data being used for generating behavior control data used for controlling behavior of a character object or a character object group that is operated by a computer in the game; and
behavior control data generation means for generating the behavior control data based on the base data acquired by the base data acquisition means,
wherein the base data acquisition means acquires a combination of operation data and state data as the base data,
the operation data being related to an operation performed by the person between a first time corresponding to a collision between the moving object and any one of predetermined objects located in the game space and a second time corresponding to a subsequent collision between the moving object and any one of the predetermined objects located in the game space,
the state data being related to a state of the plurality of character objects or the plurality of character object groups and the moving object at the first time.

2. The behavior control data generation system according to claim 1, wherein
the base data acquisition means acquires, as the base data, a combination of the operation data, first state data related to the state of the plurality of character objects or the plurality of character object groups and the moving object at the first time, and second state data related to a state of the plurality of character objects or the plurality of character object groups and the moving object at a time, or in a period, prior to the first time.

3. The behavior control data generation system according to claim 1, wherein
the base data acquisition means acquires, as the base data, a combination of the operation data, the state data, and game event data related to a game event that occurs after the first time.

4. The behavior control data generation system according to claim 1, wherein
the base data acquisition means acquires, as the base data, a combination of the operation data, the state data, and data related to a progress status of the competition at the first time.

5. The behavior control data generation system according to claim 1, wherein
the base data acquisition means acquires, as the base data, a combination of the operation data, the state data, and data related to a halfway result of the competition at the first time.

6. A generation method for behavior control data, comprising:
a play data acquisition step of acquiring
data related to change in state of a plurality of character objects or a plurality of character object groups and a moving object in a case where a person plays a game by operating any one of the plurality of character objects or any one of the plurality of character object groups, the game being configured such that the plurality of character objects or the plurality of character object groups perform a competition using the moving object within a game space, and
data related to an operation performed by the person in the case where the person plays the game by operating the any one of the plurality of character objects or the any one of the plurality of character object groups;
a base data acquisition step of acquiring base data based on the data acquired in the play data acquisition step, the base data being used for generating behavior control data used for controlling behavior of a character object or a character object group that is operated by a computer in the game; and
a behavior control data generation step of generating the behavior control data based on the base data acquired in the base data acquisition step,
wherein the base data acquisition step comprises acquiring a combination of operation data and state data as the base data,
the operation data being related to an operation performed by the person between a first time corresponding to a collision between the moving object and any one of predetermined objects located in the game space and a second time corresponding to a subsequent collision between the moving object and any one of the predetermined objects located in the game space,
the state data being related to a state of the plurality of character objects or the plurality of character object groups and the moving object at the first time.

7. A computer-readable information storage medium storing a program,
the program causing a computer to function as:
play data acquisition means for acquiring
data related to change in state of a plurality of character objects or a plurality of character object groups and a moving object in a case where a person plays a game by operating any one of the plurality of character objects or any one of the plurality of character object groups, the game being configured such that the plurality of character objects or the plurality of character object groups perform a competition using the moving object within a game space, and
data related to an operation performed by the person in the case where the person plays the game by operating the any one of the plurality of character objects or the any one of the plurality of character object groups;
base data acquisition means for acquiring base data based on the data acquired by the play data acquisition means, the base data being used for generating behavior control data used for controlling behavior of a character object or a character object group that is operated by a computer in the game; and
behavior control data generation means for generating the behavior control data based on the base data acquired by the base data acquisition means,
wherein the base data acquisition means acquires a combination of operation data and state data as the base data,
the operation data being related to an operation performed by the person between a first time corresponding to a collision between the moving object and any one of predetermined objects located in the game space and a second time corresponding to a subsequent collision between the moving object and any one of the predetermined objects located in the game space,
the state data being related to a state of the plurality of character objects or the plurality of character object groups and the moving object at the first time.

8. An information processing device, comprising:
play data acquisition means for acquiring
data related to change in state of a plurality of character objects or a plurality of character object groups and a moving object in a case where a person plays a game by operating any one of the plurality of character objects or any one of the plurality of character object groups, the game being configured such that the plurality of character objects or the plurality of character object groups perform a competition using the moving object within a game space, and
data related to an operation performed by the person in the case where the person plays the game by operating the any one of the plurality of character objects or the any one of the plurality of character object groups; and
base data acquisition means for acquiring base data based on the data acquired by the play data acquisition means, the base data being used for generating behavior control data used for controlling behavior of a character object or a character object group that is operated by a computer in the game,
wherein the base data acquisition means acquires a combination of operation data and state data as the base data,
the operation data being related to an operation performed by the person between a first time corresponding to a collision between the moving object and any one of predetermined objects located in the game space and a second time corresponding to a subsequent collision between the moving object and any one of the predetermined objects located in the game space,
the state data being related to a state of the plurality of character objects or the plurality of character object groups and the moving object at the first time.

9. A control method for an information processing device, comprising:
a play data acquisition step of acquiring
data related to change in state of a plurality of character objects or a plurality of character object groups and a moving object in a case where a person plays a game by operating any one of the plurality of character objects or any one of the plurality of character object groups, the game being configured such that the plurality of character objects or the plurality of character object groups perform a competition using the moving object within a game space, and
data related to an operation performed by the person in the case where the person plays the game by operating the any one of the plurality of character objects or the any one of the plurality of character object groups; and
a base data acquisition step of acquiring base data based on the data acquired in the play data acquisition step, the base data being used for generating behavior control data used for controlling behavior of a character object or a character object group that is operated by a computer in the game,
wherein the base data acquisition step comprises acquiring a combination of operation data and state data as the base data,
the operation data being related to an operation performed by the person between a first time corresponding to a collision between the moving object and any one of predetermined objects located in the game space and a second time corresponding to a subsequent collision between the moving object and any one of the predetermined objects located in the game space,
the state data being related to a state of the plurality of character objects or the plurality of character object groups and the moving object at the first time.

10. A computer-readable information storage medium storing a program,
the program causing a computer to function as:
play data acquisition means for acquiring
data related to change in state of a plurality of character objects or a plurality of character object groups and a moving object in a case where a person plays a game by operating any one of the plurality of character objects or any one of the plurality of character object groups, the game being configured such that the plurality of character objects or the plurality of character object groups perform a competition using the moving object within a game space, and
data related to an operation performed by the person in the case where the person plays the game by operating the any one of the plurality of character objects or the any one of the plurality of character object groups; and
base data acquisition means for acquiring base data based on the data acquired by the play data acquisition means, the base data being used for generating behavior control data used for controlling behavior of a character object or a the plurality of character object group that is operated by a computer in the game,
wherein the base data acquisition means acquires a combination of operation data and state data as the base data,
the operation data being related to an operation performed by the person between a first time corresponding to a collision between the moving object and any one of predetermined objects located in the game space and a second time corresponding to a subsequent collision between the moving object and any one of the predetermined objects located in the game space,
the state data being related to a state of the plurality of character objects or the plurality of character object groups and the moving object at the first time.
